(19) United States
(12) Patent Application Publication
(10) Pub. No.: US 2010/0059064 A1
(43) Pub. Date: Mar. 11, 2010

(54) Method and Apparatus for Using a Surgical Fixture in an Intra-Operative Computed Tomography Scanner

(76) Inventors: Edgar Franz Schüle, Freiburg (DE); Matthias Edgar Schüle, Freiburg (DE); Thomas Christian Schüle, Munich (DE); Phillip Christian Schuele, Freiburg (DE); Matthias Edgar Schuele, Freiburg (DE)

Correspondence Address: FROST BROWN TODD, LLC, 2200 PNC CENTER, 201 E. FIFTH STREET, CINCINNATI, OH, 45202, US

(21) Appl. No.: 12/437,227

(22) Filed: May 7, 2009

Related U.S. Application Data
(60) Provisional application No. 61/051,766, filed on May 9, 2008.

(51) Int. Cl. A61G 15/00

(52) U.S. Cl. 128/845

(57) ABSTRACT

A fixture for immobilizing a patient's head during a medical procedure is usable with a CT scanner. The fixture includes a skull clamp having detachable and adjustable radiolucent extensions. The radiolucent extensions include a body portion, a surgical pin holder assembly, and an attachment member. A first radiolucent extension includes a two-pin holder assembly. A second radiolucent extension includes a single-pin holder assembly. The attachment member of the radiolucent extension allows for angular adjustable attachment of the radiolucent extension to the skull clamp through corresponding starburst features. The surgical fixture may include an immobilization base unit having first and second mounting arms, a connecting arm, and a position adapter. The skull clamp with extensions attaches to the immobilization base unit to further immobilize the patient. The position adapter connects to the skull clamp and includes a rotational unit and vertical adjustment unit to position the patient as desired.

### PRIORITY

This application claims priority from the disclosure of U.S. Provisional Patent Application Ser. No. 61/051,766, entitled “Method and Apparatus for Using a Surgical Fixture in an Intra-Operative Computed Tomography Scanner,” filed May 9, 2008, the disclosure of which is incorporated by reference herein.

### BACKGROUND

During surgical operations or other procedures, a portion of the body upon which surgery is being conducted may be substantially immobilized, such as, for example, a patient's head during head or neck surgery. Such immobilization of a patient's head, for example, may be accomplished with a fixture such as a skull clamp or other fixture, as disclosed in U.S. Patent Publication No. 2006/0084900, entitled METHOD AND APPARATUS FOR ATTACHING ACCESSORIES TO A SURGICAL FIXTURE, published Apr. 20, 2006, the disclosure of which is incorporated by reference herein. Examples of cranial stabilization systems and components include any of the DORO products of pro med instruments GmbH of Freiburg, Germany.

It may be desirable to use such a cranial immobilization system or technique with a surgical procedure using intra-operative computed tomography (CT) scanning or other types of imaging (e.g., MRI, PEM, X-Ray, etc.). In some circumstances, it may be desirable and convenient to adjust the angle or configuration of the immobilization fixture for optimum surgical positioning or CT scanning. While many surgical accessories and immobilization fixtures exist, it is believed that no one prior to the inventors has created or used the invention described herein.

### BRIEF DESCRIPTION OF THE DRAWINGS

The accompanying drawings incorporated in and forming a part of the specification illustrate several aspects of the present invention, and together with the description serve to explain the principles of the invention; it being understood, however, that this invention is not limited to the precise arrangements shown. In the drawings, like reference numerals refer to like elements in the several views. In the drawings:

FIG. 1A depicts a side view of an exemplary skull clamp extension first arm.

FIG. 1B depicts an end view of the arm of FIG. 1A.

FIG. 2A depicts a side view of an exemplary skull clamp extension second arm.

FIG. 2B depicts an end view of the arm of FIG. 2A.

FIG. 3A depicts a perspective view of an exemplary skull clamp with attached radiolucent extensions.

FIG. 3B depicts a perspective view of the exemplary skull clamp of FIG. 3A with radiolucent extensions detached.

FIG. 4A depicts a first side view of the surgical fixture of FIG. 3A.

FIG. 4B depicts a second side view of the surgical fixture of FIG. 3A.

FIG. 4C depicts a front view of the surgical fixture of FIG. 3A.

FIG. 4D depicts a plan view of the surgical fixture of FIG. 3A.

FIG. 5A depicts a partial perspective view of an exemplary radiolucent extension attachment member.

FIG. 5B depicts a partial perspective view of an exemplary surgical fixture accessory receiving member.

FIG. 6A depicts a perspective view of an exemplary radiolucent extension.

FIG. 6B depicts a side view of the exemplary radiolucent extension of FIG. 6A.

FIG. 7A depicts a perspective view of an exemplary radiolucent extension.

FIG. 7B depicts a side view of the exemplary radiolucent extension of FIG. 7A.

FIG. 8 depicts a perspective view of an immobilization base unit.

FIG. 9 depicts a view of the rotational unit of FIG. 8.

FIG. 10A depicts a perspective view of the vertical adjustment unit of FIG. 8.

FIG. 10B depicts an exploded view of the vertical adjustment unit of FIG. 8.

FIG. 10C depicts a partial cross-sectional view of the positioning member of FIGS. 10A and 10B.

Reference will now be made in detail to various embodiments of the invention, examples of which are illustrated in the accompanying drawings. To the extent that specific dimensions are shown in the accompanying drawings, such dimensions should be regarded as merely illustrative and not limiting in any way. Accordingly, it will be appreciated that such dimensions may be varied in any suitable way.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the descriptions should be regarded as illustrative in nature and not restrictive.

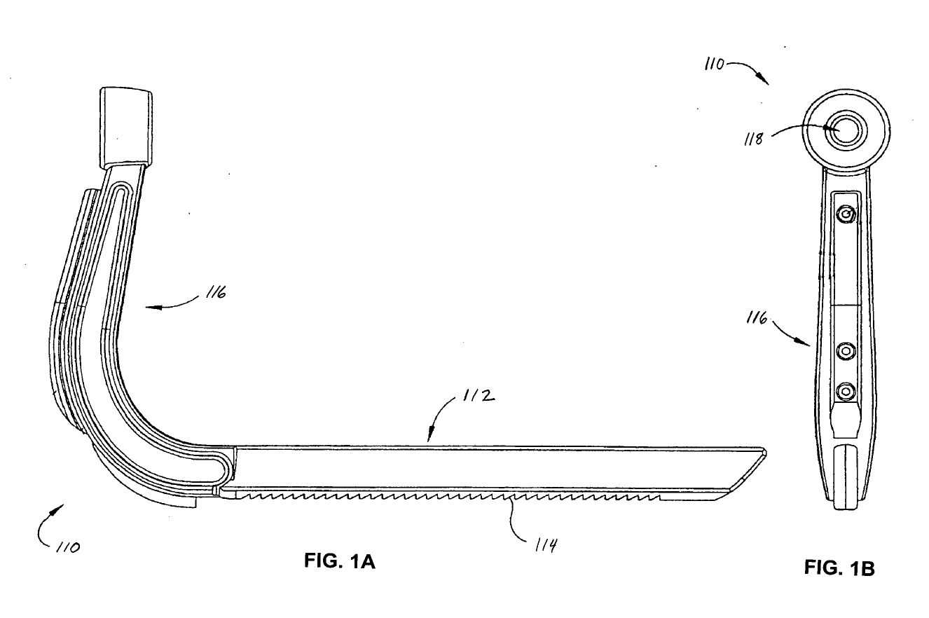

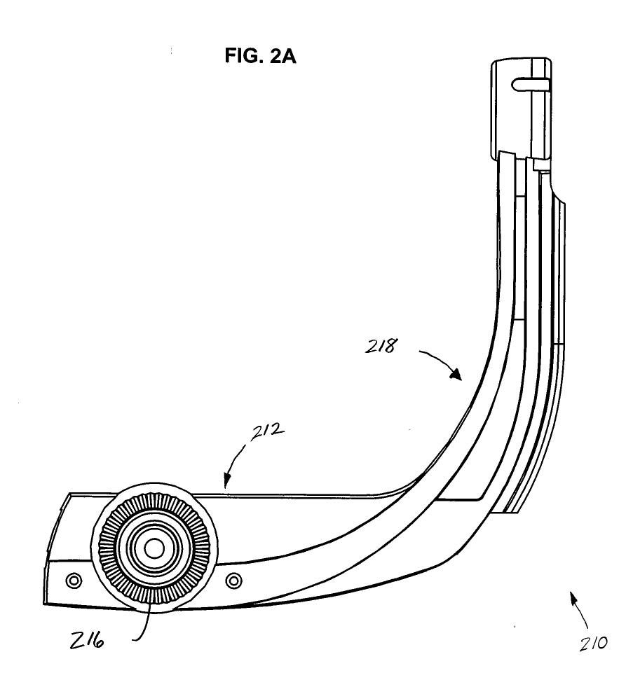

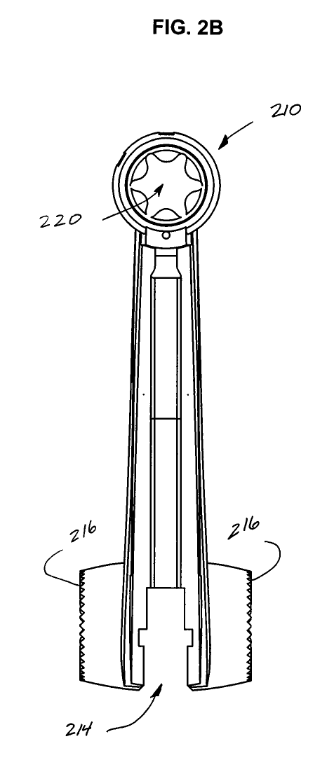

FIGS. 1A through 2B depict components of a disassembled exemplary skull clamp. As shown, the skull clamp of this example comprises a first arm (110) and a second arm (210). Arm (110) comprises an insert portion (112) and an upright portion (116). As shown, insert portion (112) is generally perpendicular to upright portion (116). It will be appreciated, however, that any other relative orientation of portions (116, 112) may be used, including but not limited to obtuse angles, acute angles, a plurality of angles, one or more curves, etc. Insert portion (112) comprises a plurality of teeth (114). The end of upright portion (116) comprises an opening (118). Opening (118) is configured to receive a variety of objects, including but not limited to skull pin receiving fixtures (not shown), other cranial stabilizing components, or any other objects.

Arm (210) comprises a receiving portion (212) and an upright portion (218). As shown, receiving portion (212) is generally perpendicular to upright portion (218). It will be appreciated, however, that any other relative orientation of portions (212, 218) may be used, including but not limited to obtuse angles, acute angles, a plurality of angles, one or more curves, etc. The end of upright portion (218) comprises an opening (220). Opening (220) is configured to receive a variety of objects, including but not limited to skull pin receiving fixtures (not shown), other cranial stabilizing components, or any other objects. Receiving portion (212) comprises a recess (214), which is configured to receive insert portion (112) of arm (110). It will be appreciated that recess (214) may be substituted or supplemented with an opening, a slot, or any other feature or configuration, or may be otherwise modified or omitted.

In the present example, arms (110, 210) are configured to form a skull clamp (10) when insert portion (112) of arm (110) is inserted in recess (214) of arm (210). Skull clamps are known in the art, and may be used for immobilizing a patient's head during head or neck surgery, by way of example only. Of course, skull clamps may be suitable for other uses. Additionally, other surgical fixtures for immobilizing parts of a patient's body during surgery or for other purposes are known in the art. It will be appreciated that the skull clamp assembly of the present example is merely illustrative, and that features of the present example may be used with any other type of component of a surgical fixture, including accessories for surgical fixtures, as well as with a variety of other fixtures and objects.

With arms (110, 210) positioned to form a skull clamp (10), it will be appreciated that arm (210) may be used as a base member, and arm (110) adjusted relative to arm (210). In other words, arm (210) may be secured to a stand, table, rail, etc., or other stationary member, and arm (110) may be adjusted relative to arm (210) to create a desired distance between upright portions (116, 218). Upon achieving the desired adjustment of arm (110) relative to arm (210), teeth (114) on insert portion (112) of arm (110) may be used to substantially secure arm (110) relative to arm (210). Of course, arm (110) may alternatively be used as a base member for a skull clamp, and arm (210) may thus be adjusted relative to arm (110). Still other suitable configurations will be apparent to those of ordinary skill in the art. By way of example only, other various features that may be incorporated into a skull clamp (10) are disclosed in U.S. Patent Publication No. 2006/0084900, entitled METHOD AND APPARATUS FOR ATTACHING ACCESSORIES TO A SURGICAL FIXTURE, published Apr. 20, 2006, the disclosure of which is incorporated by reference herein.

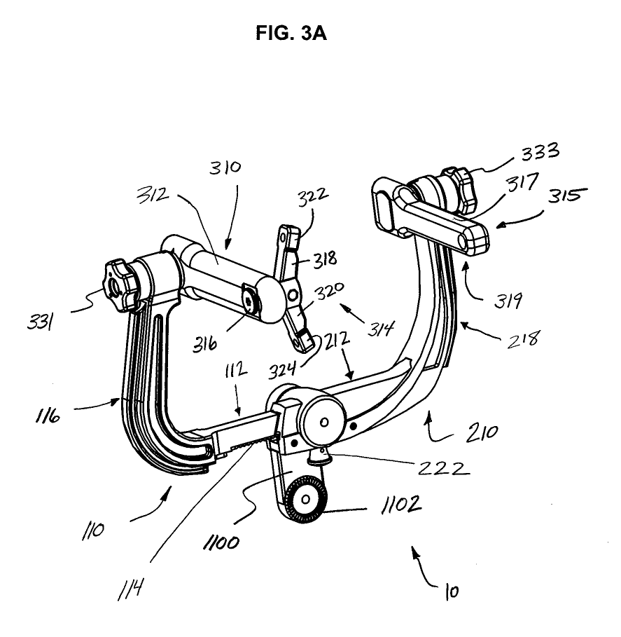

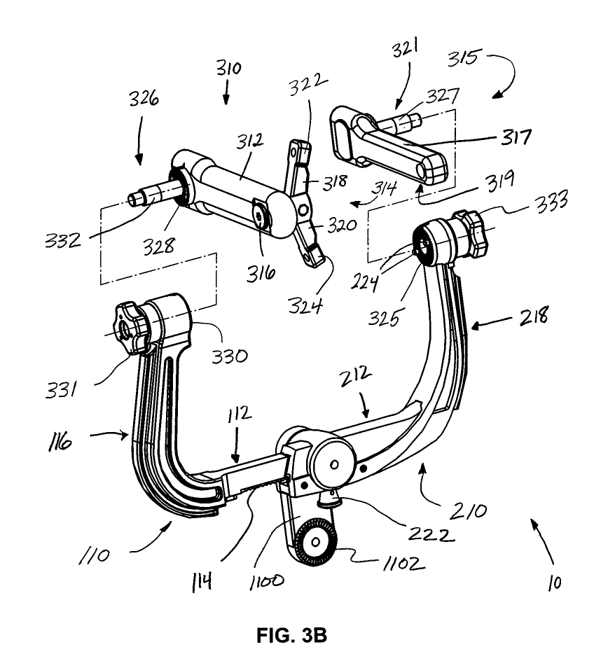

As shown in FIGS. 3A-3B, a skull clamp (10) with radiolucent extensions comprises an assembled skull clamp (10) (discussed in detail above), a first radiolucent extension (310), and a second radiolucent extension (315). Each of the radiolucent extensions (310, 315) will be described in greater detail below.

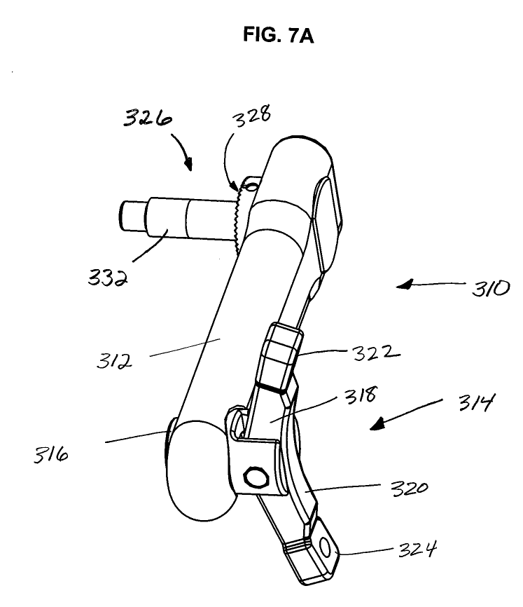

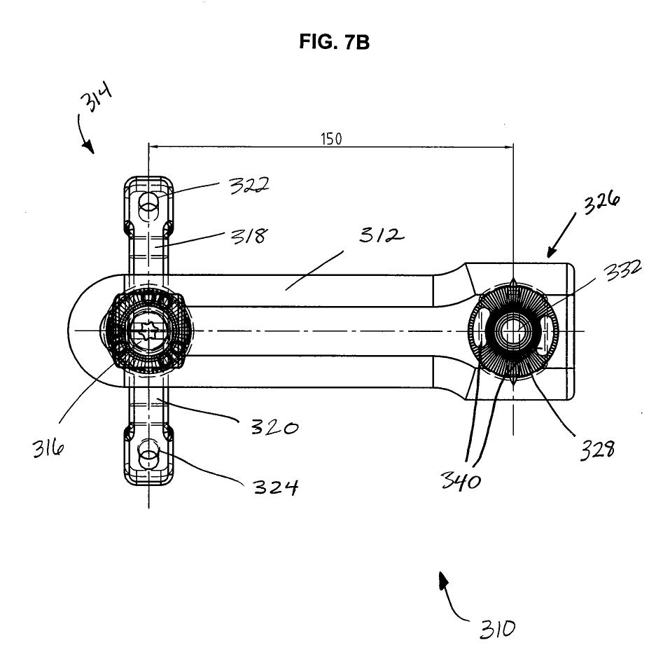

Referring to FIGS. 3B, 7A, and 7B, the first radiolucent extension (310) of the present example further comprises a body portion (312), a two-pin holder assembly (314), and an attachment member (326). However, arrangements other than a two-pin holder assembly (314) may be suitable and may include single-pin holder assemblies, gel pads, and foam pads, among others. The two-pin holder assembly (314) shown in the illustrated version provides two points of pin fixation for immobilizing a patient's head during a procedure. The two-pin holder assembly (314) further comprises a securing member (316), a first extension portion (318), a second extension portion (320), a first pin placement section (322), and a second pin placement section (324).

In one exemplary version, the securing member may be a bolt, screw, or rivet that secures the two-pin holder assembly (314) to the body portion (312) of the first radiolucent extension (310). It may be appreciated that securing member (316) may cause permanent or non-permanent attachment. For instance, two-pin holder assembly (314) may be rotated about an axis defined by securing member (316) to achieve a desired angular position of two-pin holder assembly (314) relative to body portion (312). Securing member (316) may then be manipulated (e.g., rotated within body portion (312), etc.) in order to secure the angular position of two-pin holder assembly (314) relative to body portion (312). Other securing members may be suitable as well and will be apparent to those of ordinary skill in the art.

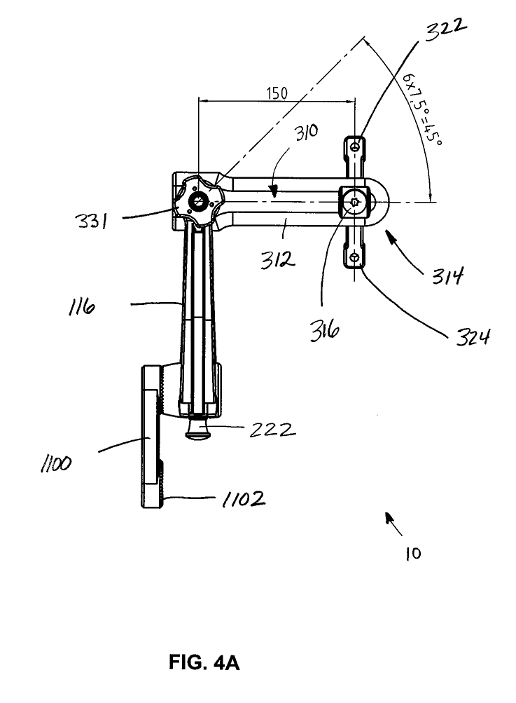

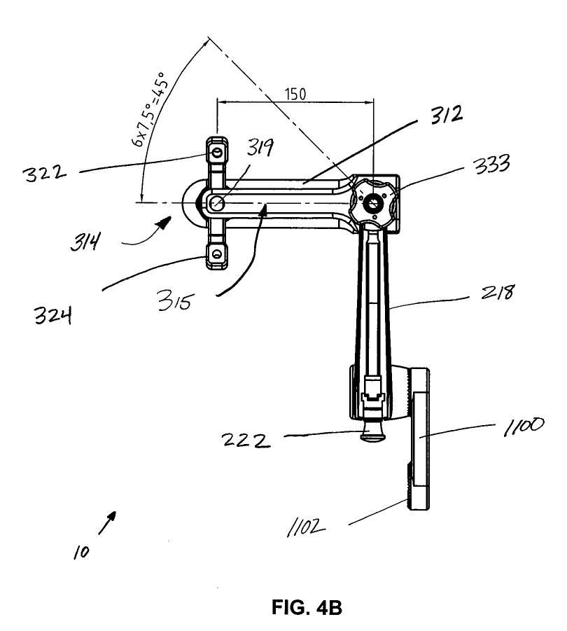

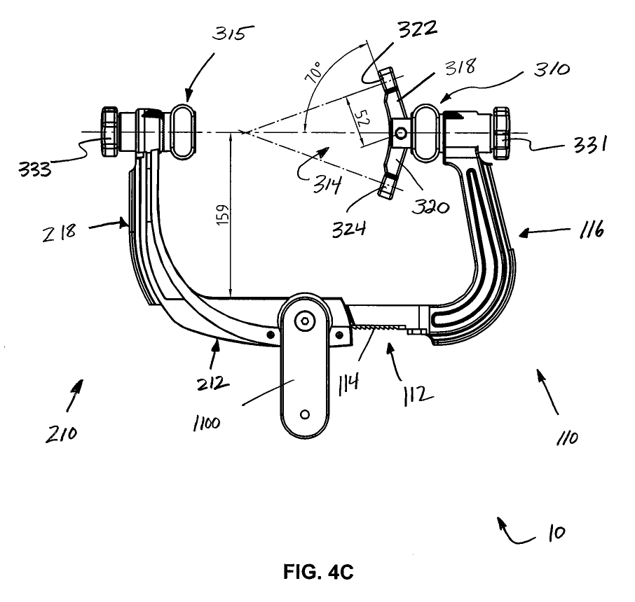

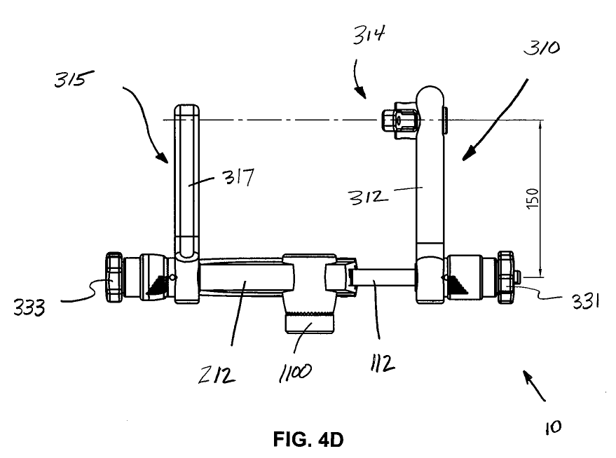

Referring also to FIG. 4C, the first and second extension portions (318, 320) may extend outward from the securing member (316) in generally opposing directions. In one exemplary version, the first and second extension portions (318, 320) converge at the securing member (316) and form a generally obtuse angle along a plane generally perpendicular to the body portion (312) of the first radiolucent extension (310). By way of example only, and not limitation, in FIG. 4C, the first and second extension portions (318, 320) may form an angle of approximately 140 degrees. In some other versions, first and second extension portions (318, 320) may be closer together as may be required for certain applications or anatomies, for example pediatric applications or patients with smaller skulls. Of course other configurations for the first and second extension portions (318, 320) may be suitable as well, and will be apparent to those of ordinary skill in the art.

Furthermore, the first extension portion (318) of the present example includes a first pin placement section (322) at one end, and the second extension portion (320) includes a second pin placement section (324) at one end. Pin placement sections (322, 324) may be configured to receive and hold skull pins to contact and/or penetrate the patient's skull during a procedure. It will be appreciated to one of ordinary skill in the art that first and second pin placement sections (322, 324) may be configured for use with other contacting or holding devices, such as screws, bolts, clamps, adhesive pads, gel pads, foam pad, and the like.

Body portion (312) of first radiolucent extension (310) may have a rounded shape so as to reduce or minimize sharp edges that may cause artifacts while scanning. For instance, body portion (312) may be of a rod or cylindrical shape that extends from the attachment member (326) to the securing member (316). In one exemplary version, attachment member (326) is positioned at one end of body portion (312) and securing member (316) is positioned at the other end of body portion (312). It will be appreciated by those skilled in the art that body portion (312) may have other suitable shapes, including but not limited to rectangular shapes having a small width dimension to maximize the space between the first and second radiolucent extensions (310, 315) for placement of a patient's head.

Body portion (312) is generally a rigid structure in this example, but those of ordinary skill in the art will appreciate that body portion (312) may be designed to have some flexible properties.

Body portion (312) of first radiolucent extension (310) may have any suitable length depending on the procedure or application. In one example, as shown in FIG. 4D, the length of body portion (312) is approximately 150 mm. Still in another example, the length of body portion (312) is approximately 120 mm. Still in another example, the length of body portion (312) is approximately 185 mm. Those of ordinary skill in the art will appreciate the various lengths of body portion (312) that are suitable for procedures where some degree of immobilization is desired.

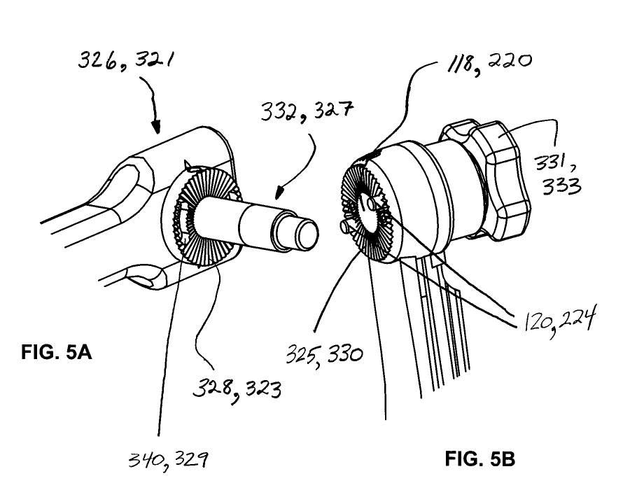

Referring now to FIGS. 3B, 5A, and 5B, the attachment member (326) of the present example connects with the opening (118, 220) in the upright portion (116, 218) of the skull clamp arm (110, 210). The attachment may be made by any suitable means. In one exemplary version, the attachment may be achieved by the attachment member (326) and the opening (118, 220) having cooperating features, such as cooperating starburst features (328, 330). Another mode of attachment may include an adjustable locking pin (332) associated with opening (118, 220). Still in other versions cooperating starburst features (328, 330) may be used in combination with an adjustable locking pin (332). In some versions, attachment member (326) has external threads that are configured to engage with internal threads that are associated with a knob (331) on skull clamp arm (110). Such threads may be engaged such that rotation of knob (331) draws starburst feature (328) toward starburst feature (330) to engage starburst features (328, 330), thereby preventing rotation of body portion (312) relative to skull clamp arm (110), when knob (331) is rotated in a first direction; and such that rotation of knob (331) urges starburst feature (328) away from starburst feature (330) to disengage starburst features (328, 330), thereby permitting rotation of body portion (312) relative to skull clamp arm (110), when knob (331) is rotated in a second direction. In some versions, attachment members (326, 321) have recessed slots (340, 329) to receive posts (120, 224) located in the upright portions (116, 218) of the skull clamp arms (110, 210). The recessed slots (340, 329) and posts (120, 224) configuration may be used with the cooperating starburst features as shown in FIGS. 5A and 5B. Use of recessed slots (340, 329) and posts (120, 224) may be used to define a desired rotation amount of the radiolucent extensions (310, 315). Other modes of attachment will be apparent to those of ordinary skill in the art.

It will further be appreciated that the attachment may permit rotation of the first radiolucent extension (310) to accommodate various desired angular positions. Such rotational attachment may be accomplished using corresponding starburst features (328, 330), an adjustable locking pin (332), or a combination. As shown in FIG. 4A, in one exemplary version, the angular adjustment of the first radiolucent extension (310) may be up to approximately 45 degrees, though any other suitable range may be used. In some versions, these adjustments may be accomplished in 7.5 degree increments, though any other suitable adjustment increment may be used. Other modes of rotational attachment will be apparent to those of ordinary skill in the art.

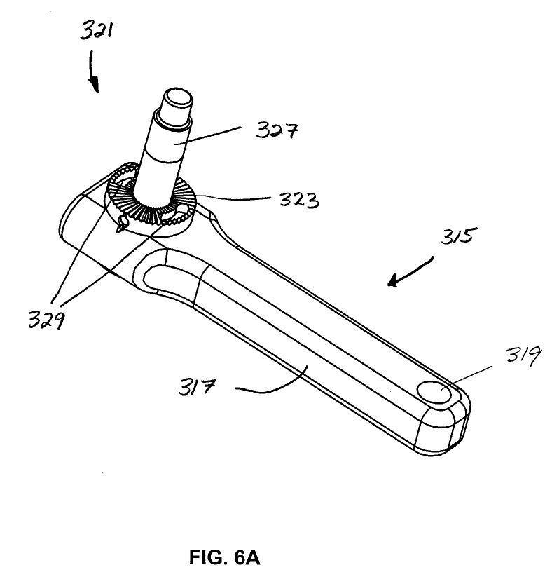

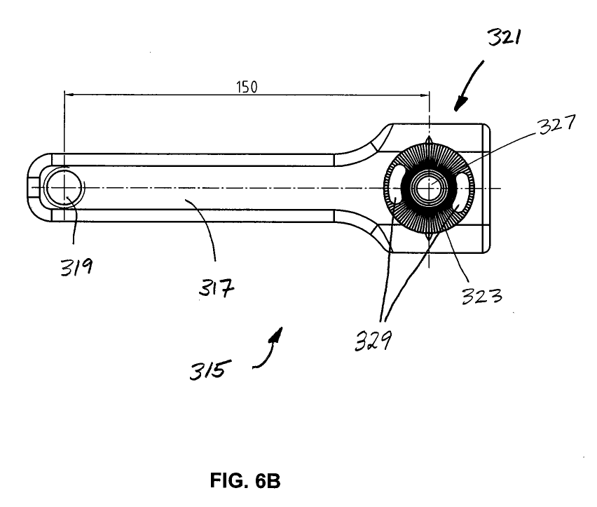

Referring to FIGS. 3B, 6A, and 6B, the second radiolucent extension (315) of the present example further comprises a body portion (317), a single-pin holder assembly (319), and an attachment member (321). However, arrangements other than a single-pin holder assembly (319) may be suitable and may include two-pin holder assemblies, gel pads, and foam pads, among others. The single-pin holder assembly (319) shown in the illustrated version provides one point of pin fixation for immobilizing a patient's head during a procedure. Of course it will be apparent to those of ordinary skill that the second radiolucent extension (315) may be configured to have multiple points of pin fixation.

Body portion (317) of second radiolucent extension (315) may have a rounded shape so as to reduce or minimize sharp edges that may cause artifacts while scanning. For instance, body portion (317) may be of a rod or cylindrical shape that extends from the attachment member (321) to the single-pin holder assembly (319). In one exemplary version, attachment member (321) is positioned at one end of body portion (317) and single-pin holder assembly (319) is positioned at the other end of body portion (317). It will be appreciated by those skilled in the art that body portion (317) may have other suitable shapes, including but not limited to, rectangular shapes having a small width dimension to maximize the space between the first and second radiolucent extensions (310, 315) for placement of a patient's head.

Body portion (317) of the present example is generally a rigid structure, but those of ordinary skill in the art will appreciate that body portion (317) may be designed to have some flexible properties.

Body portion (317) of second radiolucent extension (315) may have any suitable length depending on the procedure or application. In some versions, as shown in FIGS. 4D and 6B, the length of body portion (317) is approximately 150 mm. Still in another version, the length of body portion (317) is approximately 120 mm. Still in another example, the length of body portion (312) is approximately 185 mm. Those of ordinary skill in the art will appreciate the various other lengths of body portion (317) that are suitable for procedures where some degree of immobilization is desired.

Referring to FIGS. 5A and 5B, the attachment member (321) connects with the opening (118, 220) in the upright portion (116, 218) of the skull clamp arm (110, 210). The attachment may be made by any suitable means. Referring to FIGS. 3B and 6A, in one exemplary version, the attachment may be achieved by the attachment member (321) and the opening (118, 220) having cooperating features, such as cooperating starburst features (323, 325). Another mode of attachment may include an adjustable locking pin (327) associated with opening (118, 220). Still in other versions cooperating starburst features (323, 325) may be used in combination with an adjustable locking pin (327). In some versions, attachment member (321) has external threads that are configured to engage with internal threads that are associated with a knob (333) on skull clamp arm (210). Such threads may be engaged such that rotation of knob (333) draws starburst feature (323) toward starburst feature (325) to engage starburst features (323, 325), thereby preventing rotation of body portion (317) relative to skull clamp arm (210), when knob (333) is rotated in a first direction; and such that rotation of knob (333) urges starburst feature (323) away from starburst feature (325) to disengage starburst features (323, 325), thereby permitting rotation of body portion (317) relative to skull clamp arm (210), when knob (333) is rotated in a second direction. Other modes of attachment will be apparent to those of ordinary skill in the art.

It will be appreciated that the attachment may permit rotation of the second radiolucent extension (315) to accommodate various desired angular positions. Such rotational attachment may be accomplished using corresponding starburst features (323, 325), an adjustable locking pin (327), or a combination. In one exemplary version, as shown in FIG. 4B, the angular adjustment of the second radiolucent extension (315) may be up to approximately 45 degrees, though any other suitable range may be used. These adjustments may be accomplished in 7.5 degree increments, though any other suitable adjustment increment may be used. Other modes of rotational attachment will be apparent to those of ordinary skill in the art.

It will further be appreciated to those of ordinary skill in the art that first radiolucent extension (310) may be attached to either arm (110) or arm (210) of the skull clamp. Likewise, second radiolucent extension (315) may be attached to either arm (110) or arm (210) of the skull clamp. Of course it will be appreciated based on the teachings herein that first and second radiolucent extensions (310, 315) may be configured such that swapping their position between arms (110, 210) may still provide that the first and second radiolucent extensions (310, 315) point into the same desired direction having the same angulation capabilities as described above. For instance, in some versions a swivel or pivot joint may be included on the first and second radiolucent extensions (310, 315) to permit rotation of the head holding components such that they are oriented as desired.

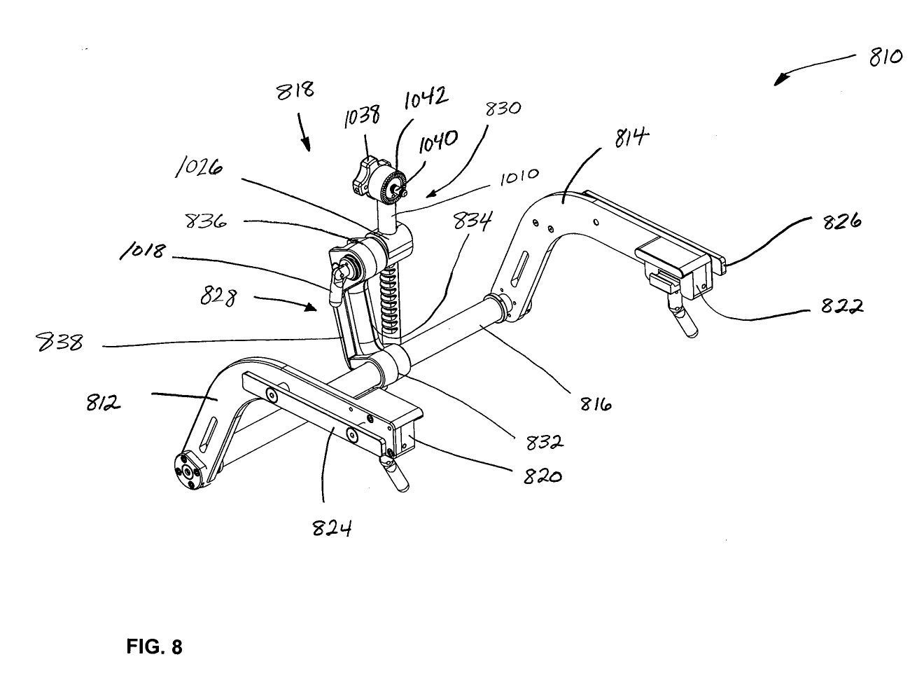

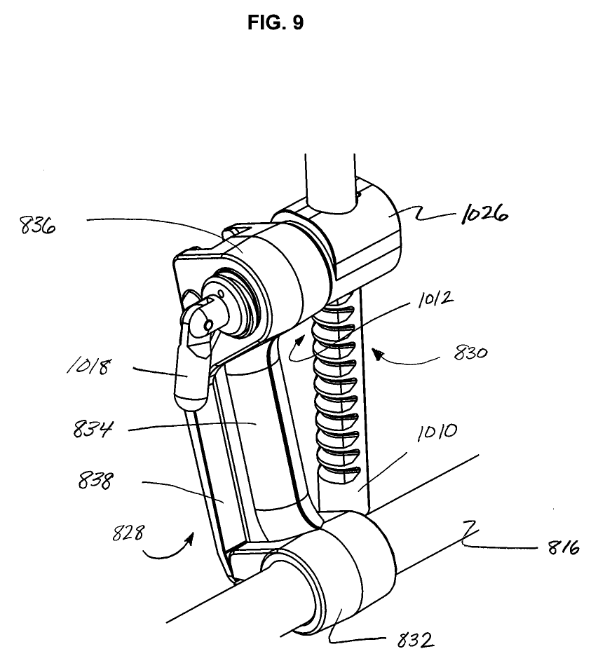

The skull clamp (10) described above may further be configured to operate with an immobilization base unit (810), such as is shown in FIGS. 8-9, which may attach directly to a table or other object. In some versions, the immobilization base unit (810) attaches directly to an operating table or imaging table for close patient positioning and clear access to an associated CT scanner. Additionally, the skull clamp (10) operative with the immobilization base unit (810) may also be configured with one or more radiolucent extensions (310, 315) as described above.

Referring now to FIG. 8, an exemplary immobilization base unit (810) is shown. The immobilization base unit (810) may be adjustable from lateral and/or vertical positions, in a variety of orientations. The immobilization base unit (810) may be constructed from any suitable material. The suitable materials of construction will be apparent to those of ordinary skill in the art. In some versions, the immobilization base unit (810) is made of stainless steel and aluminum. In other versions, the immobilization base unit (810) may be made of other metals, alloys, ceramics, composite materials, plastics, polymers, or suitable combinations of materials. In some versions, base unit (810) and/or a skull clamp, as well as any accessories or fixtures associated therewith, are formed of one or more materials that do not interfere with X-ray, CT, or MR imaging or other forms of imaging.

In the present example, the immobilization base unit (810) comprises first mounting arm (812), second mounting arm (814), connecting arm (816), and position adapter (818). Each of these components will be described in greater detail below. It will be appreciated, however, that an immobilization base unit (810) may have a variety of alternative components.

Each mounting arm (812, 814) of the present example further comprises an engaging member (820, 822) and a side rail (824, 826). Mounting arms (812, 814) may have an arcuate configuration in some versions; although other configurations are suitable and will be apparent to those of ordinary skill in the art. At one end of each mounting arm (812, 814) is an engaging member (820, 822). It will further be appreciated that the engaging members (820, 822) may be located along any suitable point of mounting arms (812, 814). Engaging members (820, 822) are configured to attach the immobilization base unit (810) to a table or other object. The attachment may be achieved in any number of ways that provides secure attachment of the device. Furthermore, the attachment may be adjustable where desired. By way of example only, and not limitation, engaging members (820, 822) may be attached to a table or other object by a compressive force, such as a clamping mechanism. Engaging members (820, 822) may also comprise one or more pins, protuberances, or other features that are configured to engage with complementary features on a table or other structure. Other suitable features, structures, and techniques for releasably securing a base unit (810) to a table or other structure will be apparent to those of ordinary skill in the art in view of the teachings herein. It will also be appreciated that, in some versions, mounting arms (812, 814) or other portions of base unit (810) may be integral with (e.g., welded to) a table or other structure.

Each of the side rails (824, 826) of the present example may be located along the side of each mounting arm (812, 814) respectively, as shown in FIG. 8. By way of example only, and not limitation, in some versions, the side rails (824, 826) may be positioned on the mounting arms (812, 814) so as to be generally parallel to the table surface. In such a configuration, side rails (824, 826) may adopt similar functionality as original table side rails customary with surgical tables. Other suitable orientations for side rails (824, 826) will be apparent to those of ordinary skill in the art and may include side rails (824, 826) having an angled orientation with respect to the table surface or object used for mounting immobilization base unit (810).

Referring to FIG. 8, on the end of mounting arms (812, 814), opposite from engaging members (822, 824), is connecting arm (816). Connecting arm (816) of this example contains two end sections. The first end section is associated with first mounting arm (812) while the second end section is associated with second mounting arm (814). Connecting arm (816) may have any suitable shape. By way of example only, and not limitation, connecting arm (816) may have a cylindrical shape or rectangular shape. The length of connecting arm (816) may be of any suitable length for permitting ease of mounting the immobilization base unit (810). In some versions connecting arm (816) may be adjustable in length to allow immobilization base unit (810) to mount to various size tables and other objects.

Connecting arm (816) and mounting arms (812, 814) may also be configured such that mounting arms (812, 814) are rotatable relative to connecting arm (816), about an axis defined by connecting arm (816). Connecting arm (816) and/or mounting arms (812, 814) may also comprise one or more features configured to selectively secure mounting arms (812, 814) relative to connecting arm (816), such as one or more features configured to selectively secure the rotational position of mounting arms (812, 814) relative to connecting arm (816). Such features may include complementary starburst features, clamping features, locking pins, or any other suitable features. Connecting arm (816) and mounting arms (812, 814) may also be configured such that the longitudinal position of one or both mounting arms (812, 814) along connecting arm (816) may be selectively adjusted. Alternatively, the longitudinal and/or rotational position of mounting arms (812, 814) relative to connecting arm (816) may be substantially fixed.

In the present example, a position adapter (818) is associated with connecting arm (816). Position adapter (818) further comprises rotational unit (828) and vertical adjustment unit (830). Rotational unit (828) is directly associated with connecting arm (816) whereas vertical adjustment unit (830) is indirectly associated with connecting arm (816) through rotational unit (828).

Rotational unit (828) of the present example further comprises first clamp portion (832), body portion (834), second clamp portion (836), and adjusting lever (838). First clamp portion (832) is located at one end of body portion (834). At the opposing end of body portion (834) is second clamp portion (836). When adjusting lever (838) is in an engaged position, adjusting lever (838) is located along body portion (834) in a generally parallel configuration. When adjusting lever (838) is disengaged, adjusting lever (838) is in a generally perpendicular configuration to body portion (834). Of course, it should be appreciated that the engagement and disengagement position of adjusting lever (838) may be varied in any suitable manner.

By way of example only, in some versions, first clamp portion (832) of rotational unit (828) includes a compressive clamp that is actuated by adjusting lever (838) and allows for position adapter (818) to be laterally adjustable along the length of connecting arm (816) as well as rotationally adjustable about connecting arm (816). Other suitable modes of associating rotational unit (828) with connecting arm (816) will be apparent to those of ordinary skill in the art.

Also by way of example only, in some versions, second clamp portion (836) of rotational unit (828) may include a compressive clamp that is also actuated by adjusting lever (838) and is associated with the vertical adjustment unit (830). Second clamp portion (836) may hold a portion of vertical adjustment unit (830), so that when adjusting lever (838) is in an engaged position, a compressive force is exerted on the portion of vertical adjustment unit (830), thereby restricting movement. When adjusting lever (838) is disengaged, the vertical adjustment unit (830) may adjustably rotate within the grasp of second clamp portion (836).

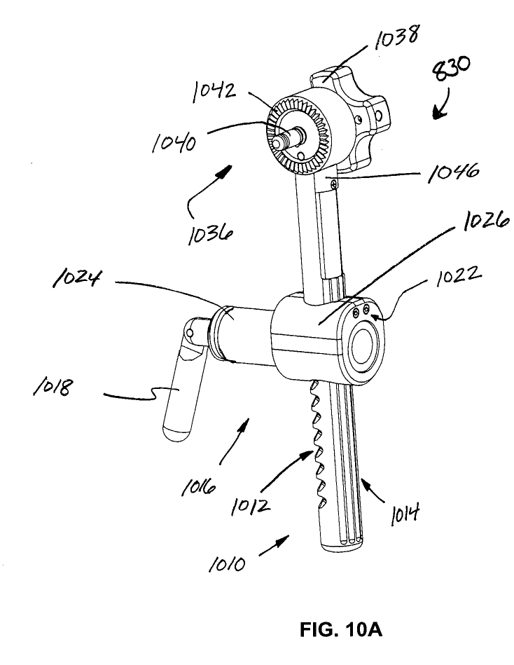

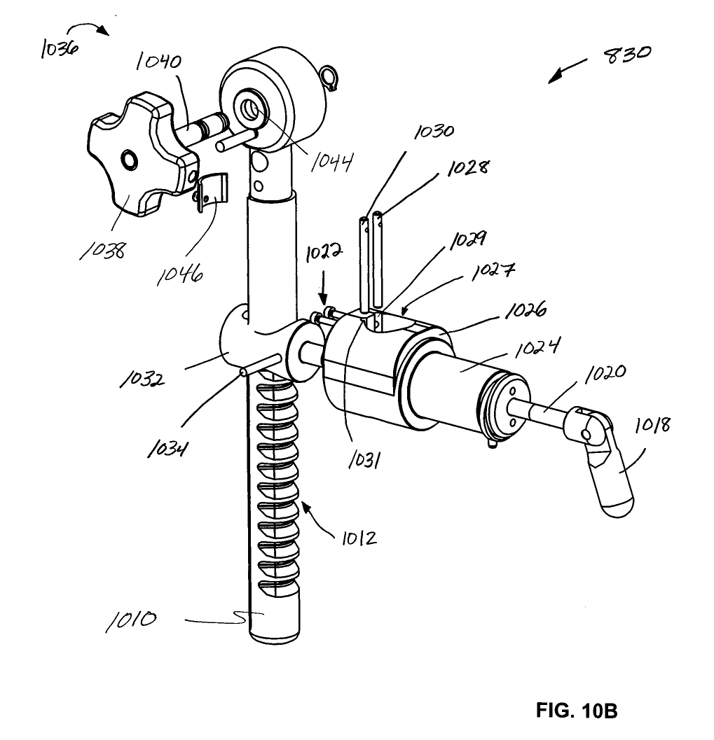

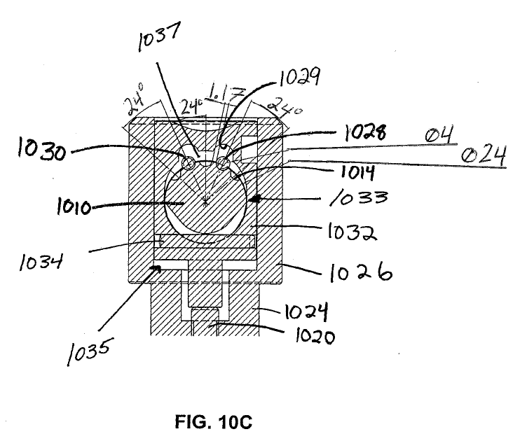

Referring to FIGS. 10A, 10B, and 10C, vertical adjustment unit (830) of the present example further comprises shaft (1010), positioning member (1016), and connection member (1036). In the present example, shaft (1010) includes horizontal recesses (1012) and vertical recesses (1014) as shown in FIGS. 10A and 10B. Horizontal recesses (1012) may be located along one side of the entire length of shaft (1010) or only along a portion of one side of the length of shaft (1010). Furthermore, horizontal recesses (1012) may be spaced at any desired distance. Horizontal recesses (1012) may also have any variety of shapes, which will be apparent to those of ordinary skill in the art.

Vertical recesses (1014) may be located along one side of the entire length of shaft (1010) or only along a portion of one side of the length of shaft (1010). Any number and shape of vertical recesses (1014) may be suitable and will be apparent to those of ordinary skill in the art. Furthermore, the spacing between vertical recesses (1014) may be of any suitable dimension. In some versions, vertical recesses (1014) are spaced through approximately 24 degrees around a portion of the perimeter of shaft (1010). By way of example and not limitation, as shown in FIGS. 10A and 10B, horizontal recesses (1012) and vertical recesses (1014) may be arranged on shaft (1010) so as to not interfere with one another. By way of example only, this may be accomplished by locating horizontal recesses (1012) on a different surface of shaft (1010) than vertical recesses (1014) as shown in FIGS. 10A and 10B.

Positioning member (1016) of the present example is configured to communicate with shaft (1010) through horizontal and vertical recesses (1012, 1014). Positioning member (1016) further comprises lever (1018), actuating rod (1020), first body portion (1024), second body portion (1026), and third body portion (1032). Third body portion (1032) is generally configurable to be located within second body portion (1026). At one end of positioning member (1016) is lever (1018). Lever (1018) may be associated with actuating rod (1020), which extends through first body portion (1024), into second body portion (1026), and is in communication with third body portion (1032).

First body portion (1024) is associated with second body portion (1026) at one end of first body portion (1024). At the opposing end of first body portion (1024), first body portion (1024) is associated with lever (1018). Extending through first body portion (1024) is actuating rod (1020), which is associated with lever (1018). Within first body portion (1024) actuating rod (1020) may traverse from a secure position to an adjusting position through manipulation of lever (1018).

In the present example, and as shown in FIG. 8, first body portion (1024) is configured to be received by second clamp portion (836) of rotational unit (828). The rotational position of positioning member (1016) relative to rotational unit (828), about an axis defined by first body portion (1024), may be adjusted when second clamp portion (836) is in a relaxed configuration. The rotational position of positioning member (1016) relative to rotational unit (828), about an axis defined by first body portion (1024), may be secured by manipulating adjusting lever (838) as described above. Alternatively, any other suitable devices, structures, features, or relationships may be employed.

Second body portion (1026) further comprises opening (1027), first vertical locking pin (1028), second vertical locking pin (1030), securing posts (1022), and clearance portion (1035), which is shown in FIG. 10C. Opening (1027) is configured to allow shaft (1010) to slide vertically within opening (1027); restrict lateral movement of shaft (1010) relative to positioning member (1016); and selectively restrict relative rotational movement between positioning member (1016) and shaft (1010) about an axis defined by shaft (1010). In some versions, by way of example only, opening (1027) may have a generally matching diameter to shaft (1010) thereby allowing shaft (1010) to slide within opening (1027). Opening (1027) further includes first vertical locking pin recess (1029) and second vertical locking pin recess (1031).

First and second vertical locking pins (1028, 1030) are arranged to align with first and second vertical locking pin recesses (1029, 1031), and vertical recesses (1014) of shaft (1010). When shaft (1010) is disposed within opening (1027) first and second vertical locking pins (1028, 1030) may be positioned such that first and second vertical locking pins (1028, 1030) mate with vertical recesses (1014) of shaft (1010) and with first and second vertical locking pin recesses (1029, 1031) of opening (1027). When locking pins (1028, 1030) are engaged with vertical recesses (1014) of shaft and with first and second vertical locking pin recesses (1029, 1031) of opening (1027), pins (1028, 1030) and recesses (1014, 1029, 1031) may prevent relative rotation between positioning member (1016) and shaft (1010), about an axis defined by shaft (1010). Ways in which pins (1028, 1030) may be selectively engaged or disengaged relative to vertical recesses (1014) of shaft (1010) and first and/or second vertical locking pin recesses (1029, 1031) of opening (1027) will be described in greater detail below.

Securing posts (1022) are positioned to engage first and second vertical locking pins (1028, 1030) so as to retain first and second vertical locking pins (1028, 1030) within second body portion (1026) such as to restrict rotational movement of shaft (1010) within opening (1027). For instance, securing posts (1022) may prevent vertical locking pins (1028, 1030) from moving longitudinally; yet may permit some degree of movement of vertical locking pins (1028, 1030) in a direction transverse to the axis defined by shaft (1010). Those of ordinary skill in the art will appreciate the numerous ways to secure first and second vertical locking pins (1028, 1030) using securing posts (1022). In the present example, securing posts (1022) engage first and second vertical locking pins (1028, 1030) by sliding through complementary openings in first and second vertical locking pins (1028, 1030).

As shown in FIG. 10C, clearance portion (1035) provides a space for third body portion (1032) when manipulating positioning member (1016) to adjust vertical position of shaft (1010). Adjusting vertical position of shaft (1010) will be discussed in greater detail below.

Third body portion (1032) of the present example further comprises opening (1033) and horizontal locking pin (1034). Opening (1033) is arranged to align with opening (1027) of second body portion (1026) when third body portion (1032) is disposed within second body portion (1026). Opening (1033) further comprises clearance portion (1037), which may make opening (1033) larger than opening (1027) of second body portion (1026).

Horizontal locking pin (1034) may be located within third body portion (1032), and is further positioned to be in selective communication with horizontal recesses (1012) of shaft (1010) when third body portion (1032) is disposed within second body portion (1026) and shaft (1010) is positioned within openings (1027, 1033). When positioning member (1016) is actuated to secure the vertical position of shaft (1010) relative to positioning member (1016), actuating rod (1020) moves third body portion (1032) such that horizontal locking pin (1034) engages a horizontal recess (1012) of shaft (1010) thereby restricting vertical movement of shaft (1010) relative to positioning member (1016). Clearance portion (1037) of opening (1033) of third body portion (1032) allows third body portion (1032) to move without interfering with first and second vertical locking pin recesses (1029, 1031) of opening (1027) of second body portion (1026).

When positioning member (1016) is actuated to adjust vertical position of shaft (1010), actuating rod (1020) moves third body portion (1032) into clearance portion (1035) of second body portion (1026), thereby disengaging horizontal locking pin (1034) from a horizontal recess (1012) of shaft (1010). With third body portion (1032) in position, shaft (1010) can be adjusted vertically relative to positioning member (1016). Positioning member (1016) can then be actuated to secure vertical position of shaft (1010) by returning third body portion (1032) to its home position once the desired vertical adjustment is complete.

It will be appreciated that, just as pin (1034) may be selectively engaged and disengaged with horizontal recesses (1012) of shaft (1010) to adjust the vertical position of shaft (1010) relative to positioning member (1016), pins (1028, 1030) may also be selectively engaged and disengaged with vertical recesses (1014) of shaft (1010) to adjust the angular orientation or rotational position of shaft (1010) relative to positioning member (1016). For instance, with pins (1028, 1030) disengaged from vertical recesses (1014), shaft (1010) may be rotated about the axis defined by shaft (1010), within positioning member (1016), until a desired angular orientation or rotational position of shaft (1010) is achieved. Positioning member (1016) may then be actuated, thereby drawing pins (1028, 1030) into engagement with a pair of vertical recesses (1014) corresponding with that angular orientation or rotational position of shaft (1010), thereby selectively securing the angular orientation or rotational position of shaft (1010) relative to positioning member (1016).

Furthermore, selective engagement/disengagement of pin (1034) and horizontal recesses (1012) and selective engagement/disengagement of pins (1028, 1030) and vertical recesses (1014) may be substantially simultaneous. Vertical and rotational positions of shaft (1010) relative to positioning member (1016) may thus be adjusted simultaneously and secured simultaneously. For instance, positioning member (1016) may be configured such that certain manipulation of lever (1018) may both urge pin (1034) toward a horizontal recess (1012) while also drawing pins (1028, 1030) toward vertical recesses (1014). Similarly, positioning member (1016) may be configured such that some other certain manipulation of lever (1018) may both draw pin (1034) away from a horizontal recess (1012) while also urging pins (1028, 1030) away from vertical recesses (1014). Suitable structures and techniques for accomplishing such actuation will be apparent to those of ordinary skill in the art in view of the teachings herein. It will also be appreciated that pin (1034, 1028, 1030) movement need not be substantially simultaneous, and may be independent. Furthermore, a variety of other types of components, structures, and devices may be used to permit selective adjustment of the vertical position of shaft (1010) relative to positioning member (1016); as well as selective adjustment of the rotational position of shaft (1010) relative to positioning member (1016).

In the present example, connection member (1036) of vertical adjustment unit (830) operates to join vertical adjustment unit (830) and immobilization base unit (810) with a device, such as the skull clamp (10) discussed previously. Connection member (1036) may use any suitable connection manner to cause such joining of immobilization base unit (810) and the desired device via vertical adjustment unit (830). Such suitable connection manners will be apparent to those of ordinary skill in the art.

In the present example, connection member (1036) further comprises a knob (1038), a support post (1040), a starburst feature (1042), and an opening (1044). Knob (1038) is attached to support post (1040). Support post (1040) may be positioned through opening (1044) for engaging a receiving connection mechanism of a skull clamp or other object. Starburst feature (1042) is located on the side of connection member (1036) opposite from knob (1038). In this configuration, connection member (1036) presents one side exposing starburst feature (1042) and support post (1040). The other side of connection member (1036) in this configuration presents knob (1038).

Starburst feature (1042) may be configured to mate with a corresponding starburst feature associated with a skull clamp (10) to yield an adjustable yet secure connection. The corresponding starburst feature associated with the skull clamp (10) may be incorporated into first or second arms (110, 210) of the skull clamp (10). The cooperation between starburst feature (1042) and the corresponding starburst feature associated with the skull clamp (10) may be accomplished directly or through an intermediary member, which may also incorporate starburst features. An exemplary intermediary member (1100) is shown in FIG. 3A, and has a starburst feature (1102) configured to mate with starburst feature (1042) of connection member (1036). The intermediary member (1100) of this example also has another starburst feature (not shown) that is configured to engage with a starburst feature (216) on arm (210). On other versions, starburst feature (1042) of connection member (1036) is engaged directly with starburst feature (216) on arm (210).

As shown in FIGS. 3A-4B, arm (210) may optionally include a quick-release knob (222) that allows for quick engagement or disengagement of the skull clamp (10) from intermediary member (1100). For instance, engagement or disengagement may be accomplished by pulling and/or rotating knob (222). Suitable internal structures for providing such operability of knob (222) will be apparent to those of ordinary skill in the art in view of the teachings herein. In addition or in the alternative, knob (222) may be operable to disengage first arm (110) relative to second arm (210). For instance, knob (222) may have a feature configured to selectively engage teeth (114). Knob (222) may also be spring-loaded such that this feature is biased to engage teeth (114). When the feature is engaged with teeth (114), the position of first arm (110) relative to second arm (210) is fixed. However, when a user pulls and/or rotates knob (222) in this example, the feature disengages teeth (114), thereby permitting adjustment of the position of first arm (110) relative to second arm (210). Knob (222) may thus be used as a “quick-release” to open the skull clamp (10).

It should be apparent that starburst feature (1042) and the starburst feature associated with the skull clamp (10) may be substituted by any other suitable attachment mechanism that provides for secure yet adjustable attachment. By way of example only, and not limitation, a series of bolts with corresponding nuts and a plurality of receiving holes may be used to adjustably, yet securely, join the skull clamp (10) or other object to immobilization base unit (810).

When connection member (1036) is engaged with a receiving connection mechanism of a skull clamp (10) or other object, knob (1038) may be turned in a rotational manner to secure the connection between vertical adjustment unit (830) and the skull clamp (10) or other object. Similarly, knob (1038) may be turned in an opposite rotational manner to interrupt the connection between vertical adjustment unit (830) and the skull clamp (10) or other object. Such an interruption may be a complete separation of the skull clamp (10) or other object from connection member (1036), or a partial separation sufficient to allow for desired positioning between connection member (1036) and the skull clamp (10) or other object. Of course, any other suitable devices, structures, or features may be used in addition to or in lieu of knob (1038).

Referring to FIGS. 10A and 10B, an additional feature of connection member (1036) includes a clip (1046). Clip (1046) is associated with shaft (1010) and connection member (1036) and operates to secure connection member (1036) to shaft (1010). In an exemplary configuration, connection member (1036) and shaft (1010) may be two independent components that engage one another and are secured by clip (1046). It should also be appreciated that clip (1046) may be omitted or substituted with other securing mechanisms. By way of example only, in some embodiments connection member (1036) and shaft (1010) are of integral or unitary construction. Still in other embodiments, connection member (1036) and shaft (1010) may be permanently attached by welding or other fastening means.

In view of the foregoing, it will be appreciated that a skull clamp (10) may be adjustably secured relative to a table or other structure by using a base unit (810) and a vertical adjustment unit (830), among other components. The base unit (810) may be configured to permit adjustable positioning of the vertical adjustment unit (830) relative to the table. The vertical adjustment unit (830) may be configured to permit adjustable positioning of a skull clamp relative to the base unit (810). In some settings, such adjustability may be desirable, such as to facilitate imaging of at least a portion of a patient's head (e.g., perform brain scan). For instance, some imaging devices (e.g. CT scanner, MRI scanner) may have a bore, gantry, or other structural feature that some conventional skull fixation devices would not fit through or would otherwise structurally interfere with. Using components described herein, adjustments may be made that may permit at least a portion of the patient's head and at least a portion of a skull fixation device to fit through the bore or gantry of an imaging device. Such imaging settings may include intra-operative imaging (e.g., imaging before, during, and/or after surgery), without the need for the patient to be removed from the skull clamp for imaging and replaced within the skull clamp for surgery. For instance, a cranial stabilization system as described herein may be adjusted to fit at least partially through the bore or gantry of a CereTom CT scanner by Neurologica Corp. of Danvers, Mass. Such a bore may have a diameter of approximately 32 cm. Of course, other imaging systems may be used. Other settings in which adjustability of a skull fixation device might be desirable will be apparent to those of ordinary skill in the art in view of the teachings herein.

As also noted above, any of the components of the devices described herein may be formed of one or more materials that will have either no effect on imaging of a patient whose skull is secured by a skull clamp or an acceptable effect on such imaging. In other words, materials may be selected such that a patient's brain may be imaged while the patient's head is secured with a skull clamp, without the presence of the skull clamp having an adverse effect on such imaging. By way of example, suitable materials may be non-ferrous and non-magnetic and may include such materials as polyether-etherketone (PEEK) or other suitable thermoplastics or thermosetting plastics, which may or may not include glass-fiber and/or carbon-fiber reinforcement. Still yet in other versions duroplastic may be used. Other suitable materials for providing such results will be apparent to those of ordinary skill in the art in view of the teachings herein.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of whatever claims recite the invention, and is understood not to be limited to the details of structure and operation shown and described in the description.

What is claimed is:

1. A fixture for use with an imaging apparatus to stabilize a portion of a patient, the fixture comprising:
a. a clamp, wherein the clamp comprises a first portion and a second portion, wherein the first and second portions each have a first end;
b. a first extension member extending from the first end of the first portion of the clamp, wherein the first extension member further comprises:
i. a body portion having a first region and a second region, wherein the body portion comprises an arm extending transversely relative to the first portion of the clamp;
ii. a stabilizing assembly, wherein the stabilizing assembly is associated with the first region of the body portion;
iii. an attachment assembly, wherein the attachment assembly is associated with the second region of the body portion and the first end of the first portion of the clamp; and
c. a second extension member extending from the first end of the second portion of the clamp, wherein the second extension member further comprises:
i. a body portion having a first region and a second region, wherein the body portion comprises an arm extending transversely relative to the second portion of the clamp;
ii. a stabilizing assembly, wherein the stabilizing assembly is associated with the first region of the body portion of the second extension member;
iii. an attachment assembly, wherein the attachment assembly is associated with the second region of the body portion of the second extension member and the first end of the second portion of the clamp.

2. The fixture of claim 1, wherein the first and second extension members are constructed from a radiolucent material, wherein the first and second extension members are configured to extend within the imaging apparatus.

3. The fixture of claim 2, wherein the clamp is positioned outside of the imaging apparatus while the first and second extension members extend within the imaging apparatus.

4. The fixture of claim 1, wherein the attachment assemblies are configured to selectively permit rotation of the first and second extension members relative to the first ends of the first and second portions of the clamp respectively.

5. The fixture of claim 4, wherein the attachment assemblies comprise at least one recessed slot configured to engage with at least one corresponding post of the first ends of the first and second portions of the clamp.

6. The fixture of claim 4, wherein the stabilizing assemblies of the first and second extension members are configured to engage the patient, wherein one of the stabilizing assemblies comprises two or more points of fixation to engage the patient.

7. The fixture of claim 6, wherein the stabilizing assemblies comprise three total points of fixation to engage the patient.

8. The fixture of claim 6, wherein the stabilizing assembly comprising two or more points of fixation further comprises a dual pin holder, wherein the dual pin holder comprises a first pin-holding extension and a second pin-holding extension, wherein the first and second pin-holding extensions extend from a common connecting point.

9. The fixture of claim 8, wherein the dual pin holder is rotatable and wherein the first and second pin-holding extensions are adjustable with respect to an angle defined by the first and second pin-holding extensions.

10. A positioning unit for use with a localization system, the positioning unit comprising:
a. an elongated member, wherein the elongated member comprises a plurality of recesses;
b. a first receiving member having an opening, wherein the first receiving member is configured to receive the elongated member through the opening;
c. a first locking member associated with the first receiving member, wherein the first locking member is configured to selectively engage with a first selected one of the plurality of recesses of the elongated member; and
d. an actuating member associated with the first locking member, wherein the actuating member is operable to translate the first locking member for selective engagement of the first locking member with the first selected one of the plurality of recesses of the elongated member.

11. The positioning unit of claim 10, wherein the positioning unit further comprises:
a. a second receiving member having an opening, wherein the second receiving member is configured to receive the elongated member through the opening, wherein the opening of the second receiving member is configured to align with the opening of the first receiving member;
b. a second locking member associated with the second receiving member, wherein the second locking member is configured to selectively engage with a second selected one of the plurality of recesses of the elongated member; and
wherein the actuating member is further associated with the second locking member, wherein the actuating member is further operable to translate the elongated member within the openings of the first and second receiving members for selective engagement of the second locking member with the second selected one of the plurality of recesses of the elongated member.

12. The positioning unit of claim 11, wherein the first receiving member is located within the second receiving member.

13. The positioning unit of claim 11 further comprising a connection member slidingly disposed within the elongated member, wherein the connection member includes at least one bore for receiving a protrusion of a locking clip associated with the elongated member.

14. The positioning unit of claim 13, wherein the connection member is connected to a skull clamp.

15. The positioning unit of claim 11, wherein the plurality of recess of the elongated member comprise a plurality of horizontal recesses and a plurality of vertical recesses, wherein the first locking member is configured to selectively engage a selected one of the plurality of horizontal recesses and the second locking member is configured to selectively engage a first selected one of the plurality of vertical recesses.

16. The positioning unit of claim 15, further comprising a third locking member associated with the second receiving member, wherein the third locking member is configured to selectively engage a second selected one of the plurality of vertical recesses of the elongated member, wherein the actuating member is further operable to translate the elongated member within the openings of the first and second receiving members for selective engagement of the third locking member with the second selected one of the plurality of vertical recesses.

17. The positioning unit of claim 16, further comprising dual post members associated with the second receiving member, wherein the dual post members retain the second and third locking members within the opening of the second receiving member.

18. The positioning unit of claim 16, wherein the actuating member comprises:
a. a lever, selectively positionable in a locked or unlocked state;
b. an actuating rod coupled with the lever, wherein the actuating rod is extended when the lever is in the locked state, and wherein the actuating rod is partially retracted when the lever is in the unlocked state; and
c. a plunger connected to the actuating rod, wherein the plunger is in communication with the first locking member to translate the first locking member for selective engagement with the selected one of the plurality of horizontal recesses, wherein the plunger is further operable to translate the elongated member for selective engagement with the second and third locking members.

19. The positioning unit of claim 16, further comprising a third receiving member, wherein the third receiving member is configured to fit within a clamp of the localization system, wherein the positioning unit is rotatable about an axis defined by the third receiving member.

20. A method for stable positioning of a patient's head within an imaging device having a gantry, wherein the method comprises the acts of:
a. adjusting vertical position of a first positioning unit, wherein the act of adjusting vertical position comprises:
i. disengaging a first locking pin of the first positioning unit from a first horizontal recess of the first positioning unit, wherein the first horizontal recess is included on a shaft of the first positioning unit;
ii. sliding the shaft of the first positioning unit from a first vertical position to a second vertical position;
iii. engaging the first locking pin of the first positioning unit with a second horizontal recess of the first positioning unit, wherein the second horizontal recess is included on the shaft of the first positioning unit;
b. adjusting rotational position of the first positioning unit, wherein the act of adjusting rotational position comprises:
i. disengaging a second locking pin of the first positioning unit from a first vertical recess of the first positioning unit, wherein the first vertical recess is included on the shaft of the first positioning unit;
ii. rotating the shaft of the first positioning unit about a longitudinal axis defined by the shaft;
iii. engaging the second locking pin of the first positioning unit with a second vertical recess of the first positioning unit, wherein the second vertical recess is included on the shaft of the first positioning unit;
c. adjusting rotational position of a second positioning unit, wherein the second positioning unit is associated with a head support at a first end, wherein the head support is associated with the first positioning unit, wherein the second positioning unit further extends from the head support into the gantry of the imagining device and is configured to engage the patient at a second end;
d. adjusting rotational position of a third positioning unit, wherein the third positioning unit is associated with the head support at a first end, wherein the third positioning unit further extends from the head support into the gantry of the imagining device and is configured to engage the patient at a second end.
